(19) United States
(12) Patent Application Publication
(10) Pub. No.: US 2010/0281078 A1
(43) Pub. Date: Nov. 4, 2010

(54) DISTRIBUTED DATA REORGANIZATION FOR PARALLEL EXECUTION ENGINES

(75) Inventors: Taifeng Wang, Beijing (CN); Tie-Yan Liu, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/433,880

(22) Filed: Apr. 30, 2009

(51) Int. Cl. G06F 7/00; G06F 17/30; G06F 3/048

(52) U.S. Cl. 707/812; 715/764; 707/E17.009; 707/E17.044

(57) ABSTRACT

A distributed data reorganization system and method for mapping and reducing raw data containing a plurality of data records. Embodiments of the distributed data reorganization system and method operate in a general-purpose parallel execution environment that use an arbitrary communication directed acyclic graph. The vertices of the graph accept multiple data inputs and generate multiple data inputs, and may be of different types. Embodiments of the distributed data reorganization system and method include a plurality of distributed mappers that use a mapping criteria supplied by a developer to map the plurality of data records to data buckets. The mapped data record and data bucket identifications are input for a plurality of distributed reducers. Each distributed reducer groups together data records having the same data bucket identification and then uses a merge logic supplied by the developer to reduce the grouped data records to obtain reorganized data.

### BACKGROUND

General-purpose parallel execution environments make it easier for a software developer to write efficient parallel and distributed applications. This distributed computing model is based on the fact that large-scale internet services are increasingly relying on multiple general-purpose servers and by predictions that future increases in local computing power will come from multi-core processors rather than improvements in speed or parallelism of a single core processor.

General-purpose parallel execution environments take advantage of the concept that one of the easiest ways to achieve scalable performance is to exploit data parallelism. Existing general-purpose parallel execution environments that exploit this parallelism are shader languages (developed for graphic processing units (GPUs)), Map/Reduce programming models for mapping and reducing large data sets, and parallel databases. In each of these programming paradigms the system dictates a communication graph but makes it simple for a software developer to supply subroutines to be executed at specified graph vertices. These systems automatically provide the necessary scheduling and distribution once an application has been written by the developer. The developer does not need to understand standard concurrency mechanisms such as threads and fine-grain concurrency control, which are known to be difficult to program correctly. Instead the system runtime abstracts these issues from the developer, and also deals with many of the hardest distributed computing problems, most notably resource allocation, scheduling, and the transient or permanent failure of a subset of components in the system. In addition, these general-purpose parallel execution environments allow developers to work at a suitable level of abstraction for writing scalable applications since the resources available at execution time are not generally known at the time the code is written.

Each of the aforementioned general-purpose parallel execution environments restrict an application's communication flow for different reasons. In particular, GPU shader languages are strongly tied to an efficient underlying hardware implementation that has been tuned to give good performance for common graphics memory-access patterns. The Map/Reduce programming model was designed to be accessible to the widest possible class of developers, and therefore aims for simplicity at the expense of generality and performance. Parallel databases were designed for relational algebra manipulations (such as structure query language (SQL)) where the communication graph is implicit.

One recent system that overcomes the above restrictions on an application's communication flow is the Dryad system by Microsoft® corporation. Dryad is a general-purpose distributed data-parallel execution engine for coarse-grain data-parallel applications. An application written on top of Dryad combines computational “vertices” with communication “channels” to form a dataflow graph. Dryad runs this type of application by executing the vertices of this graph on a set of available computers, communicating as appropriate through files, TCP pipes, and shared-memory FIFOs.

The vertices provided by the application developer usually are simple and written as sequential programs with no thread creation or locking. Concurrency arises from Dryad scheduling vertices to run simultaneously on multiple computers, or on multiple CPU cores within a computer. The application can discover the size and placement of data at run time, and modify the graph as the computation progresses to make efficient use of the available resources. Dryad is designed to scale from powerful multi-core single computers through small clusters of computers to data centers with thousands of computers. The Dryad execution engine handles all the difficult problems of creating a large distributed, concurrent application including scheduling the use of computers and their CPUs, recovering from communication or computer failures, and transporting data between vertices.

The Dryad system allows a developer fine control over the communication graph as well as the subroutines that live at its vertices. A Dryad application developer can specify an arbitrary directed acyclic graph to describe the application's communication patterns, and express the data transport mechanisms (such as files, TCP pipes, and shared-memory FIFOs) between the computation vertices. This direct specification of the graph also gives the developer greater flexibility to easily compose basic common operation. This leads to a distributed analogue of “piping” together traditional Unix® utilities such as grep, sort and head.

Dryad allows graph vertices (and computations in general) to use an arbitrary number of inputs and outputs. On the other hand, shader languages allow multiple inputs but generate a single output from the user's perspective (even though SQL query plans internally use multiple-output vertices). The MapReduce programming model restricts all computations to take a single input set and generate a single output set. The fundamental difference between Dryad and the MapReduce programming model is that a Dryad application may specify an arbitrary communication directed acyclic graph rather than requiring a sequence of map/distribute/sort/reduce operations. In particular, graph vertices may consume multiple inputs and generate multiple outputs, and may be of different types. For many applications this simplifies the mapping from algorithm to implementation, builds on a greater library of basic subroutines, and together with the ability to exploit TCP pipes and shared-memory for data edges, can bring substantial performance gains.

Dryad, however, is a lower-level programming model than SQL or DirectX. In order to get the best performance from a native Dryad application, the developer must understand the structure of the computation and the organization and properties of the system resources. Dryad was designed to be a suitable infrastructure on which to layer simpler, higher-level programming models. These rely on Dryad to manage the complexities of distribution, scheduling, and fault-tolerance, but hide many of the details of the underlying system from the application developer. They use heuristics to automatically select and tune appropriate Dryad features, and thereby get good performance for most simple applications.

Dryad can also be used with a scripting interface called the “Nebula” scripting language. The Nebula scripting language is layered on top of Dryad. Nebula allows a user to specify a computation as a series of stages, where each stage takes inputs from one or more previous stages or the file system. Nebula transforms Dryad into a generalization of the Unix® piping mechanism and it allows programmers to write giant acyclic graphs spanning many computers. Often a Nebula script only refers to existing executables such as perl or grep, allowing a user to write an entire complex distributed application without compiling any code. Nebula hides most of the details of the Dryad program from the developer. Stages are connected to preceding stages using operators that implicitly determine the number of vertices required. For example, a “Filter” operation creates one new vertex for every vertex in its input list, and connects them pointwise to form a pipeline. An “Aggregate” operation can be used to perform exchanges and merges. The implementation of the Nebula operators makes use of dynamic optimizations but the operator abstraction allows users to remain unaware of the details of these optimizations. When used together, the resulting distributed execution engine is called DryadNebula.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the distributed data reorganization system and method add a mapping and reducing layer on top of a general-purpose parallel execution environment (such as DryadNebula). Embodiments of the distributed data reorganization system and method both map and reduce raw data containing a plurality of data records to obtain reorganized data. Embodiments of the distributed data reorganization system and method allow a developer to build simpler and higher-level programming abstractions for specific application domains on top of the execution environment. This significantly lowers the barrier to entry and increases the acceptance of general-purpose parallel execution environments among domain experts who are interested in using such general-purpose parallel execution environments for rapid application prototyping.

Embodiments of the distributed data reorganization system and method include both mapping and reducing the raw data that contains a plurality of data records. The method provides a general-purpose parallel execution environment that uses an arbitrary communication acyclic graph. The vertices of the graph consume multiple data inputs and generate multiple data outputs. The vertices of the graph typically represent a different computing device in the distributed environment.

Embodiments of the system include a plurality of distributed mappers and a plurality of distributed reducers. Each distributed mapper defines data buckets that each contain a unique data bucket identification. Based on a mapping criteria supplied by a developer, each of the distributed mappers assigns a data record to a particular data bucket based on the mapping criteria. Embodiments of the system include a mapper user interface that allow the developer to input the mapping criteria through the user interface. The output of each of the distributed mappers are mapped data records and associated data bucket identification.

Each of the distributed reducers inputs the mapped data records and the data bucket identification. Data record selection is performed by each distributed reducer to group together data records that have the same data bucket identification. This generates sets of reducable data records. Each distributed reducer reduces the number of data records in each of the sets of reducable data records based on a merge logic. The merge logic, which provides instructions on how to reduce or merge the plurality of data records, is obtained from the developer. Embodiments of the system also include a reducer user interface that allows a developer to input the merge logic. The output of each distributed reducer are reorganized data records.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of a distributed data reorganization system implemented in a general-purpose distributed execution environment.

FIG. 2 is a block diagram illustrating a general overview of embodiments of the distributed data reorganization system and method disclosed herein.

FIG. 3 is a block diagram illustrating details of a single instance of the plurality of distributed mappers shown in FIG. 2.

FIG. 4 is a block diagram illustrating details of a single instance of the plurality of distributed reducers shown in FIG. 2.

FIG. 5 is a flow diagram illustrating the operation of embodiments of the distributed data reorganization system 100 and method.

FIG. 6 is a flow diagram illustrating the detailed operation of embodiments of the distributed mapper shown in FIG. 3.

FIG. 7 is a flow diagram illustrating the detailed operation of embodiments of the distributed reducer shown in FIG. 4.

FIG. 8 is an exemplary implementation of the distributed data reorganization system 100 and method shown in FIGS. 1-7.

FIG. 9 illustrates an example of a suitable computing system environment in which embodiments of the distributed data reorganization system 100 and method shown in FIGS. 1-8 may be implemented.

### DETAILED DESCRIPTION

In the following description of embodiments of the distributed data reorganization system and method reference is made to the accompanying drawings, which form a part thereof, and in which is shown by way of illustration a specific example whereby embodiments of the distributed data reorganization system and method may be practiced. It is to be understood that other embodiments may be utilized and structural changes may be made without departing from the scope of the claimed subject matter.

### I. System Overview

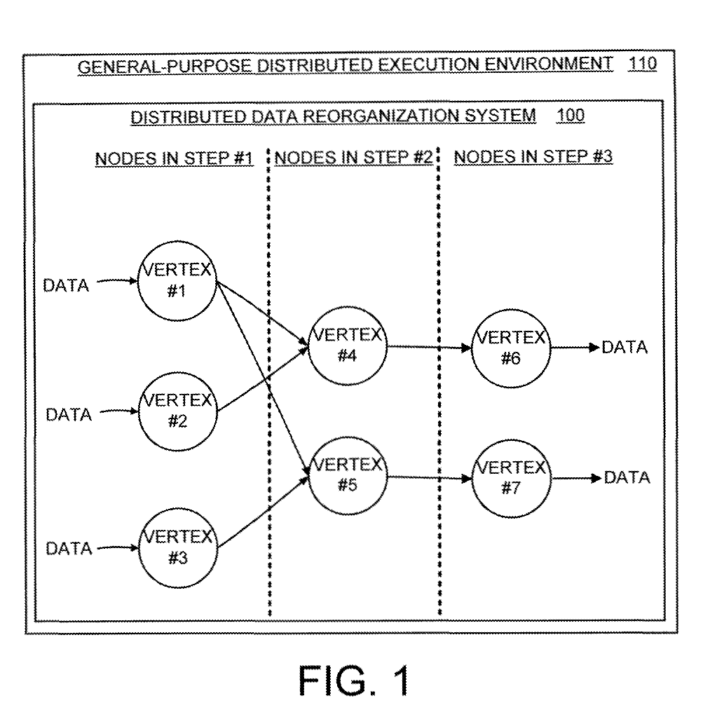

FIG. 1 is a block diagram illustrating a general overview of a distributed data reorganization system 100 implemented in a general-purpose distributed execution environment 110. In particular, FIG. 1 shows how working nodes of the general-purpose distributed execution environment 110 (such as DryadNebula) work together. The circles in FIG. 1 represent a vertex (or working node) of the general-purpose distributed execution environment 110. In FIG. 1, the vertices go from vertex #1 to vertex #7. Moreover, the arrow lines indicate a data transferring relationship, meaning that data is transferred between nodes.

The distributed data reorganization system 100 is built on top of the general-purpose distributed execution environment 110. The system 100 can be decomposed to several steps. Each step will be launched on work vertices by the general-purpose distributed execution environment 110 in a computer cluster. As described below, the general-purpose distributed execution environment 110 will intelligently schedule these vertices to work together according to the idea specified in the algebra designed by application developers. As shown in FIG. 1, the general-purpose distributed execution environment 110 begins the process at the working node (executable on a particular machine) to begin working on its input data and generates output data for its successive nodes.

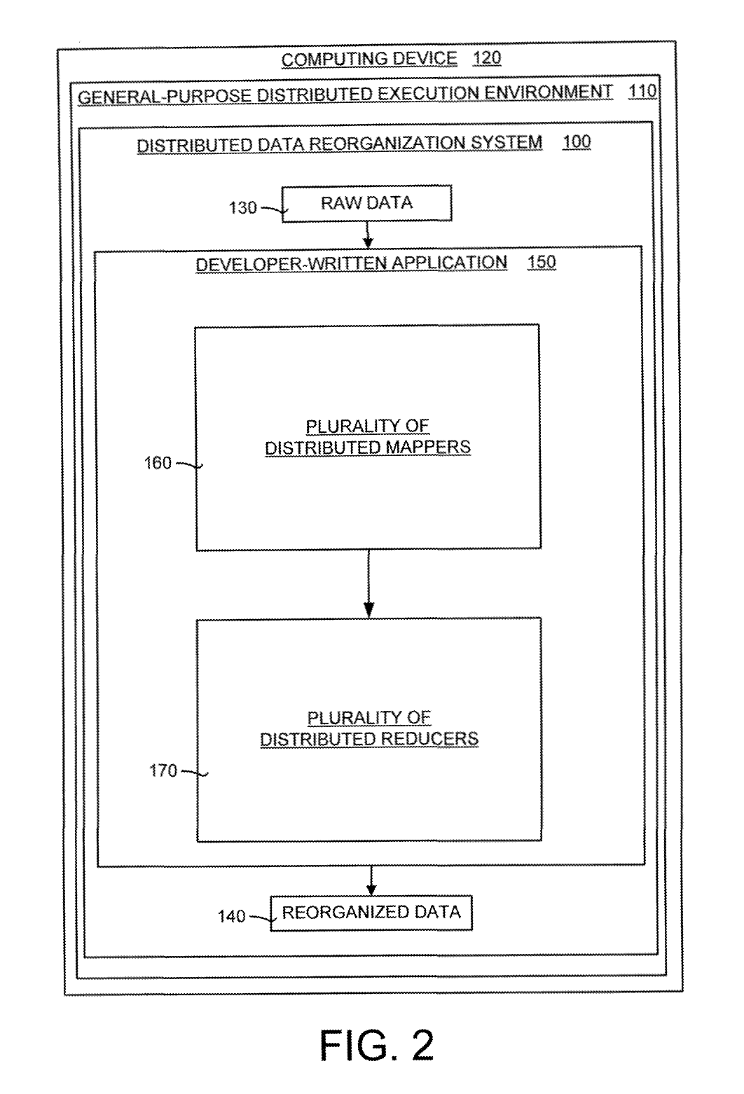

FIG. 2 is a block diagram illustrating a general overview of embodiments of the distributed data reorganization system 100 and method disclosed herein. It should be noted that the implementation shown in FIG. 2 is only one of many implementations that are possible. Referring to FIG. 2, the distributed data reorganization system 100 is shown implemented on a computing device 120. It should be noted that the computing device 120 may include a single processor (such as a desktop or laptop computer) or several processors and computers connected to each other

In general, embodiments of the distributed data reorganization system 100 process multiple input raw data 130 by mapping and reducing the data and output reorganized data 140. In particular, a developer-written application 150 runs on the system 100. The application 150 includes a plurality of mappers 160, which is a collection of individual mappers, and a plurality of reducers 170, which is a collection of individual reducers. As explained in detail below, the plurality of mappers 160 and the plurality of reducers set forth a framework in which the developer (through the application 150) can decide how the raw data 130 is mapped and reduced.

The system 100 input the raw data 130 and the plurality of mappers 160 process the input data and generate some output data. Generally, the output from the plurality of mappers 160 is in different data buckets. Each of the plurality of reducers 170 will input one of the buckets from each of the mappers and reduce all the data from that particular data bucket and then generate output from that data bucket. The output is the reorganized data 140.

### II. System Details

The distributed data reorganization system 100 includes both a plurality of distributed mappers 160 and a plurality of distributed reducers 170. Each of the plurality of mappers 160 processes input data and generates some output data, where the output data is mapped into different data buckets. Each of the plurality of reducers 170 will input one of the data buckets from every mapper, and reduce all the data from that particular data bucket, and then generate output from that data bucket.

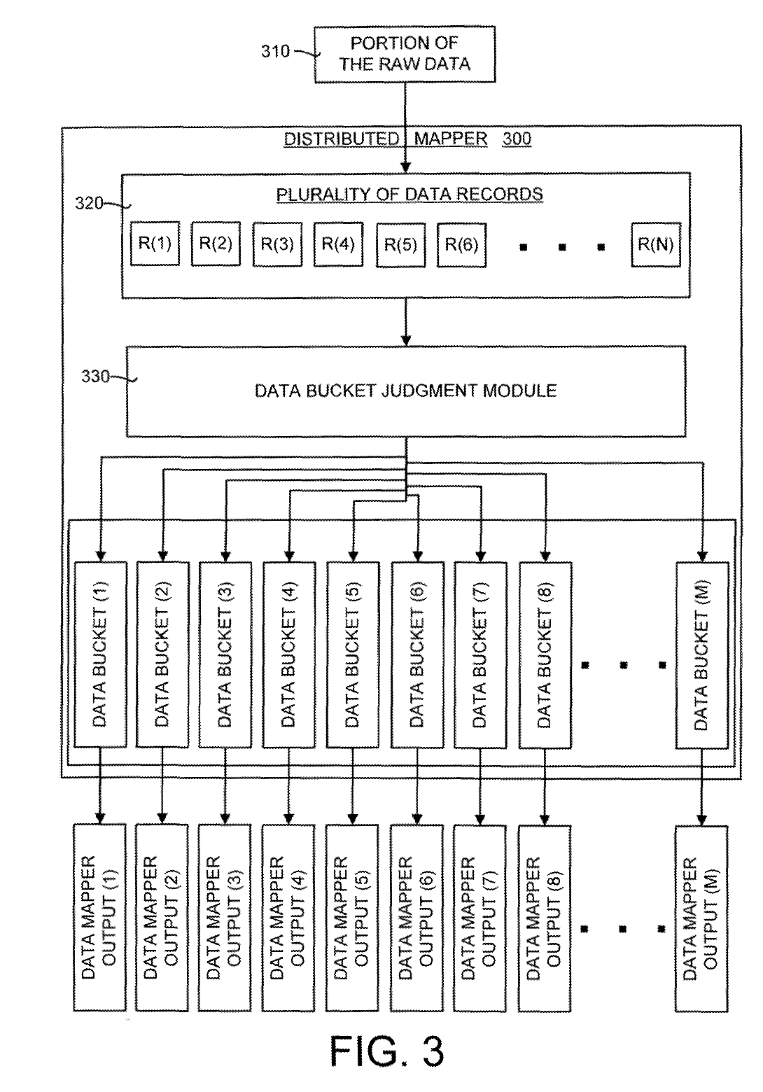

FIG. 3 is a block diagram illustrating details of a single instance of the plurality of distributed mappers 160 shown in FIG. 2. In particular, a distributed mapper 300 receives as input a portion of the raw data 310. This portion of the raw data 310 contains data records. The distributed mapper 300 divides the portion of the raw data 310 into a plurality of data records 320. As shown in FIG. 3, the plurality of data records 320 are shown as R(1), R(2) to R(N), where N is the number of data records in the portion of the raw data 310.

As explained in detail below, the distributed mapper 300 is a class that provides one major interface which is Push(T*). A user can use this interface to push data into the distributed mapper 300. The distributed mapper 300 takes care of the remaining data bucketing and related works, and outputs data for next working node in the job executing in the general-purpose distributed execution environment 110.

In particular, the distributed mapper 300 includes a data bucket judgment model 330. The data bucket judgment model 330 relies on some mapping criteria to determine to which data bucket to send each record in the plurality of data records 320. This mapping criteria is specified by a developer in the developer-written application 150. The distributed mapper 300 is just a library for every application. The application has some logic that allows it to read the data input. After it gets any data record, then the distributed mapper 300 will input at least some of the data records 320. Then the distributed mapper 300 library will take over any remaining jobs. Data records will go from the application level to data bucket judgment module 330 in the distributed mapper 300.

The data bucket judgment module 330 uses the developer-supplied mapping criteria to determine where the data should go to, in terms of the data buckets. After the data is judged as to where it should go, the distributed mapper 300 will output the data into different data buckets. In FIG. 3, the data buckets are shown as Data Bucket (1), Data Bucket (2), to Data Bucket (M), where M is a number of data buckets. In some embodiments the output of the distributed mapper 300 is a plurality of data in Data Mapper Output (1), Data Mapper Output (2), to Data Mapper Output (M). In some embodiments, different data buckets will go into different data outputs from the distributed mapper 300. In this manner, the plurality of distributed mappers 160 can work together to output data.

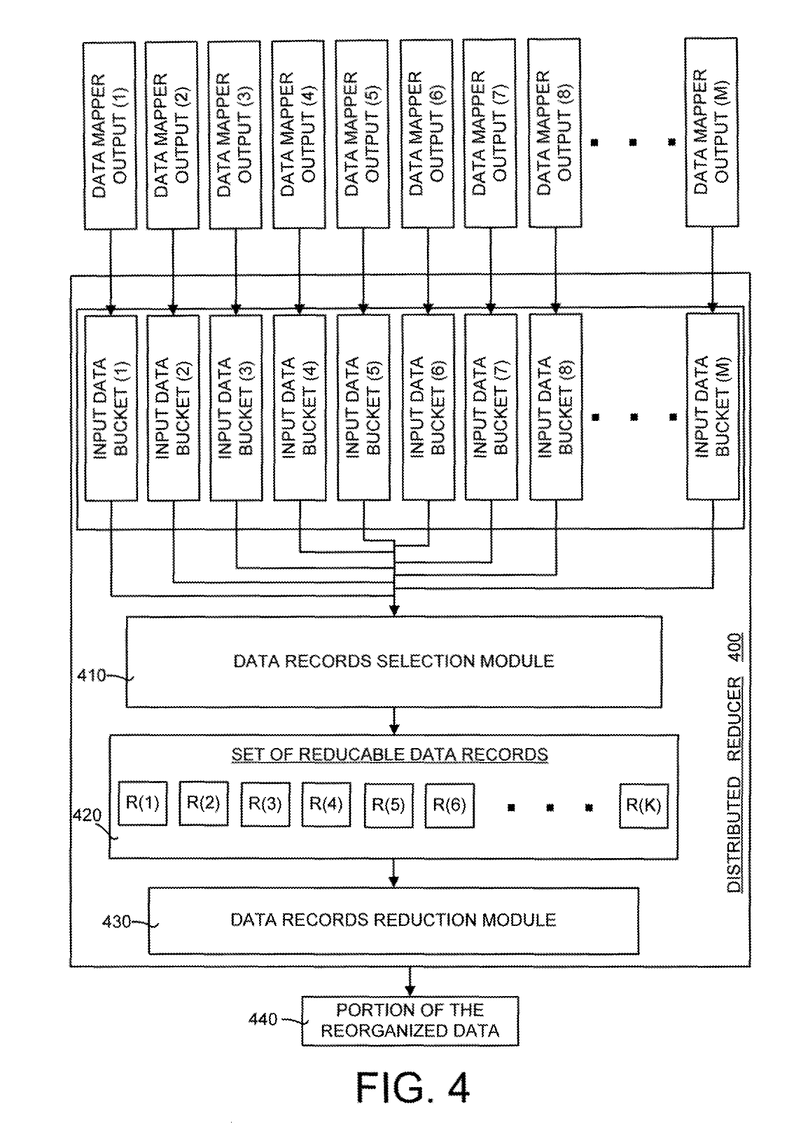

FIG. 4 is a block diagram illustrating details of a single instance of the plurality of distributed reducers 170 shown in FIG. 2. The general idea a distributed reducer 400 shown in FIG. 4 is to group or aggregate data together. In particular, as shown in FIG. 4, in some embodiments the input to the distributed reducer 400 comes from the distributed mapper 300. The Data Mapper Output (1) to Data Mapper Output (M) is input to the distributed mapper 400. The Data Mapper Output (1) to (M) is placed in Input Data Bucket (1) to Input Data Bucket (M).

In other embodiments, the input of the distributed reducer 400 is from multiple distributed mappers. For example, there may be a distributed mapper 1, having a plurality of outputs designated 1.0, 1.1, and 1.2, a distributed mapper 2, having outputs designated 2.0, 2.1, and 2.2, and distributed mapper 3 having outputs 3.0, 3.1, and 3.2. In these embodiments, the distributed mapper outputs 1.0, 2.0, and 3.0 are input to one distributed reducer, such as the distributed reducer 400. Each of the distributed reducers then are looped for all inputs from the different plurality of mappers 160.

For example, assume there are three distributed mappers and three outputs for each of the distributed mappers. This means that the three distributed mappers will output three data buckets. In this case, each input to each of the plurality of distributed reducers 170 comes from the same data bucket (or output) of the plurality of distributed mappers 160. In this way, all the data is fed from the plurality of distributed mappers 160 to the plurality of distributed reducers 170. This means that the input data buckets of the plurality of distributed reducers 170 are filled by the output from the plurality of distributed mappers 160.

The data records from the Input Data Bucket (1) to Input Data Bucket (M) are processed by a data records selection module 410. As explained in detail below, the data records selection module 410 groups together those data records having the same data bucket identification. This generates a set of reducable data records 420 containing records R(1) to R(K), where K is the number of reducable data records.

The set of reducable data records 420 is input to a data records reduction module 430. This module 430 reduces the number of data records in the set of reducable data records 420 based on merge logic provided by a developer. By way of example, the merge logic may state that records sharing the same data bucket identification are reduced into a single data record. The merge logic is set forth by the developer using an interface function that is ReduceOnInputs(InputPipe*). The developer can call this function to process the input data from superior nodes, and the distributed reducer 400 helps to generate the final merged data. The output of the distributed reducer 400 is a portion of the reorganized data 440.

It should be noted that both the distributed mapper 300 and the distributed reducer 400 are just framework classes that do not determine the data bucketing method and data reducing method. In other words, the way in which the raw data is mapped and the way in which the mapped data is reduced is not specified by the system 100. Instead, the system facilitates the developer setting forth these application specific functions in developer-defined data structures. Specifically, the mapping criteria used by the data bucket judgment model 330 and the merge logic used by the data records reduction module 430 is specified by one or more developers in the developer-defined data structures of the developer-written application 150.

### III. Operational Overview

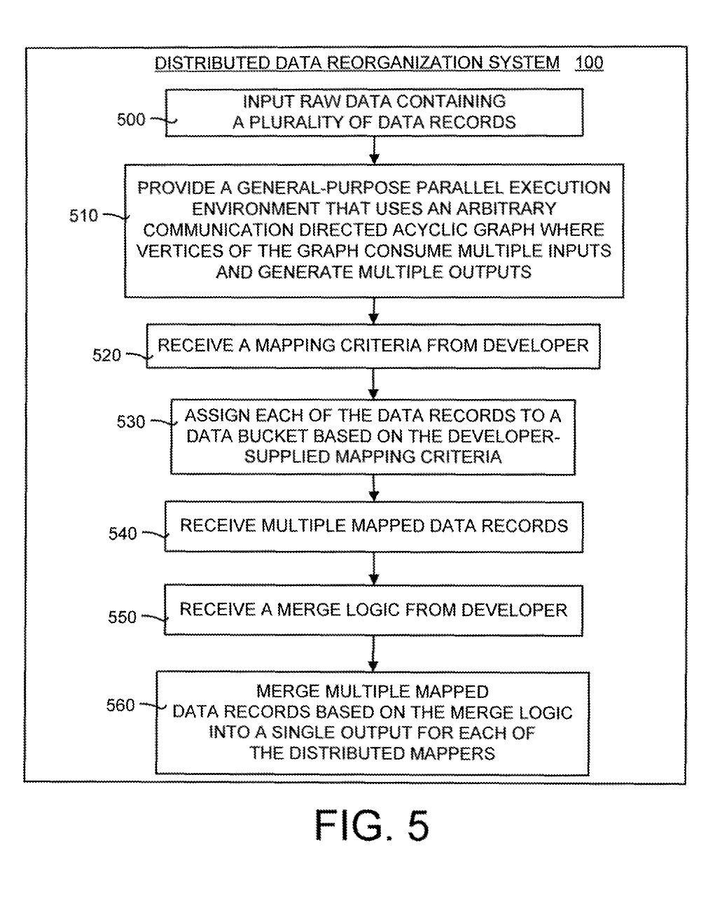

FIG. 5 is a flow diagram illustrating the operation of embodiments of the distributed data reorganization system 100 and method. In general, embodiments of the distributed data reorganization method take raw data containing a plurality of data records, process the data in accordance with instructions received from a developer, and output reorganized data.

Referring to FIG. 5, the method begins by inputting raw data containing a plurality of data records (box 500). The method operates in a general-purpose parallel execution environment that uses an arbitrary communication directed acyclic graph (box 510). The vertices of the graph consume multiple inputs and generate multiple outputs. In addition, the inputs and output may be of different types. For many applications this simplifies the mapping from algorithm to implementation, builds on a greater library of basic subroutines, and together with the ability to exploit TCP pipes and shared-memory for data edges, brings substantial performance gains.

Next, a developer provides a mapping criteria (box 520). Based on this mapping criteria, the method assigns each of the data records to a data bucket based on the developer-supplied mapping criteria (box 530). The reducer of the system 100 then receives multiple mapped data records (box 540). In addition, the reducer receives a merge logic from a developer (box 550). This merge logic provides instructions on how the multiple mapped data records should be reduced. The method then merges the multiple mapped data records based on the merge logic (box 560).

### IV. Operational Details

The operational details of embodiments of the distributed data reorganization system 100 and method now will be discussed. These embodiments include embodiments of the distributed mapper 300 and the distributed reducer 400 shown in FIGS. 3 and 4. The operational details of each of these programs modules now will be discussed in detail.

In the distributed data reorganization system 100 and method, the plurality of mappers 160 and the plurality of reducers 170 reorganize the input data records in a distributed way. Each instance of a mapper from of the plurality of distributed mappers 160, such as the distributed mapper 300, works together to dispatch the raw inputs into data buckets according to the requirements of the reorganization task. Each instance of a reducer from the plurality of distributed reducers 170, works together to merge the data within the same data bucket. The number of the plurality of distributed mappers 160 is determined by a raw data partition, while the number of the plurality of distributed reducers 170 is determined by the reorganized data partition.

### IV.A. Distributed Mapper

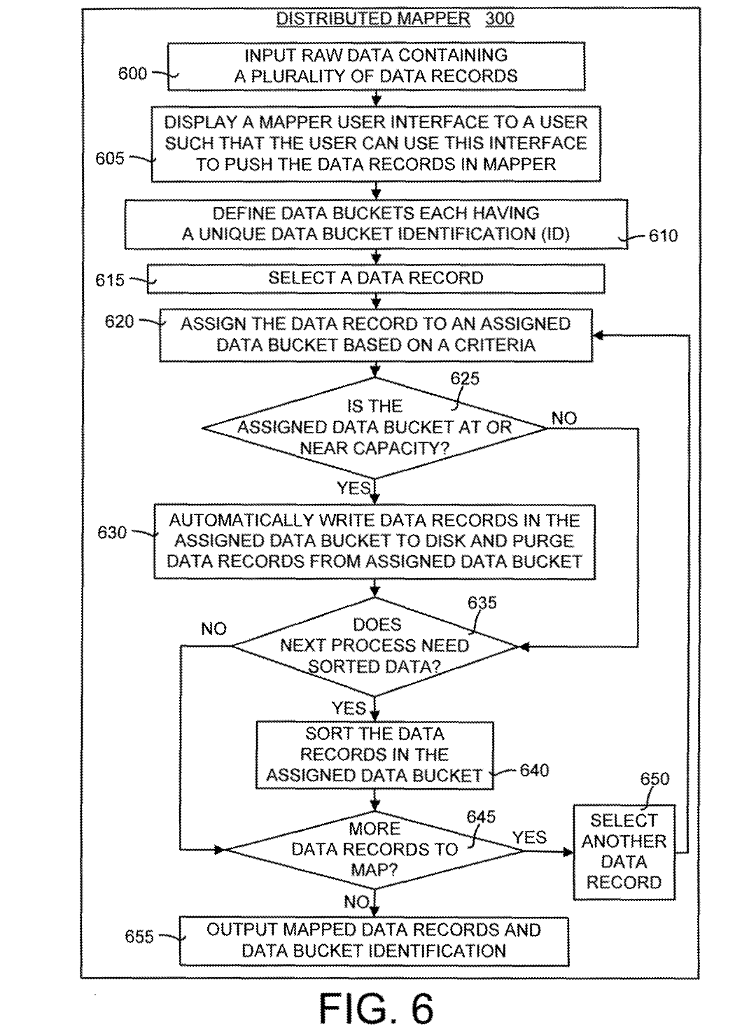

FIG. 6 is a flow diagram illustrating the detailed operation of embodiments of the distributed mapper 300 shown in FIG. 3. It should be noted that the operation of the distributed mapper 300 is an exemplary operation of each instance of a mapper from the plurality of mappers 160 shown in FIG. 2.

The operation of the distributed mapper 300 begins by inputting raw data containing a plurality of data records (box 600). A mapper user interface is displayed to a user or developer such that the developer can use the user interface to push the plurality of data records into the distributed mapper 300 (box 605). Next, data buckets are defined such that each data bucket has a unique data bucket identification (box 610).

A data record then is selected from the plurality of data records (box 615). Next, the data record is assigned to a particular assigned data bucket based on some mapping criteria (box 620). In some embodiments this mapping criteria is defined by a developer. Based on the mapping criteria, the distributed mapper 300 assigns the data record to a corresponding data bucket (box 620).

Each data bucker in the distributed mapper 300 also has the following features to aid each data bucket in fulfilling its role in the mapping process. First, a determination is made as to whether the assigned data bucket is at or near its memory capacity (box 625). If so, then the data records in the assigned data bucket are automatically written to disk and purged from the assigned data bucket (box 630). This automatic disk dumping allows data in the buckets to be automatically dumped onto disk when data in the assigned data bucket get accumulated. This feature is designed to control the memory cost of the distributed mapper 300.

If the assigned data bucket is not at or near its memory capacity, then another determination is made as to whether a subsequent or next process requires sorted data as input (box 635). This sorting feature sorts data in the data buckets when necessary. If the next process needs sorted data, then the data records in the data bucket gets sorted before they are output from the distributed mapper 300 (box 640). Considering the possibility of huge data processing, embodiments of the distributed mapper 300 includes both in-memory sorting and out-memory sorting.

If the data does not need to be sorted, then a determination is made as to whether there are more data records to map (box 645). If so, then another data record is selected (box 650) and the process begins again from the point at which the data record is assigned to some data bucket based on a mapping criteria (box 620). If there are no more data records to map, then the output of the distributed mapper 300 are the mapped data records and the data bucket identification for each mapped data record (box 655).

Once the data bucket judgment is complete, each of the data records will be assigned to a corresponding data bucket. Through this mechanism, the input data records will be divided into several parts regarding to the dividing criteria defined with the data record type, and also get well processed before it goes to the next working nodes.

In some embodiments, another feature of each data bucket is inner reducing. Inner reducing reduces the data in the data buckets. In some cases, this reduction process can greatly reduce the size of the data output from the distributed mapper 300 without any damage to the data completeness.

### IV.B. Distributed Reducer

The distributed reducer 400 receives multiple inputs and merges them into one output based on a merge logic. The merge logic can be simple combination, removing duplication, or merging based on data bucket identification. The distributed reducer 400 focuses on the duplication removing and merging based on data bucket identification. For these kinds of reducing, the inputs are sorted according to the same key.

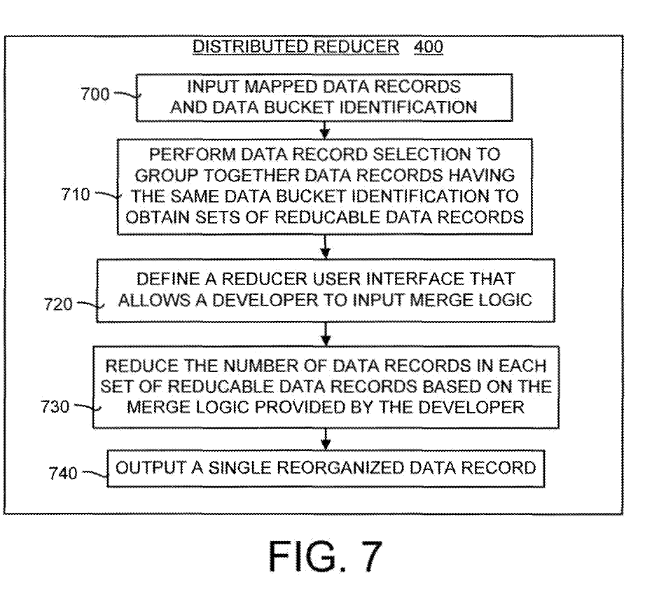

FIG. 7 is a flow diagram illustrating the detailed operation of embodiments of the distributed reducer 400 shown in FIG. 4. It should be noted that the operation of the distributed reducer 400 is an exemplary operation of each reducer in the plurality of reducers 170 shown in FIG. 2.

The operation of the distributed reducer 400 begins by inputting mapped data records and data bucket identification (box 700). Next, the reducer 400 performs data record selection to group together data records that have the same data bucket identification (box 710). This generates sets of reducable data records.

A reducer user interface then is defined that allows a developer or other user to input merge logic (box 720). This merge logic is used to reduce the number of data records in each set of reducable data records (box 730). This reduction is performed based on the merge logic provided by the developer. The output of the reducer is a single reorganized data record (box 740).

### IV.C. Exemplary Implementation

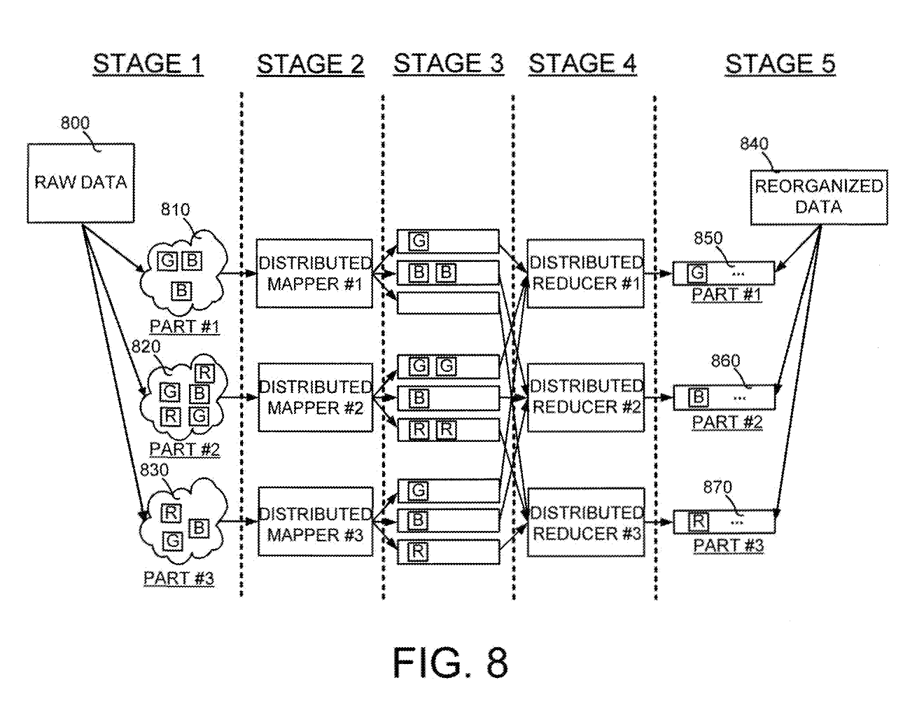

FIG. 8 is an exemplary implementation of the distributed data reorganization system 100 and method shown in FIGS. 1-7. It should be noted that the exemplary implementation shown in FIG. 8 is only one of many implementations that are possible. Referring to FIG. 8, the vertical dotted lines represent the different stages in the distributed data reorganization process. Each of these stages 1-5 typically is distributed among a plurality of computing devices.

In the first stage at the leftmost portion of FIG. 8, it can be seen that raw data 800 is divided or partitioned into three parts: Part #1 810, Part #2 820, and Part #3 830. Note that each of the data parts 810, 820, 830 contained data records, with each data record being represented by a block with a “G”, “B”, or “R” inside the block. It should be noted that “G” stands for a green block, “B” stands for a blue block, and “R” stands for a red block. The color representation of the blocks is merely to indicate that certain blocks or data records contain data or features that are similar to each other.

Referring to FIG. 8, it can be seen that Part #1 810 contains one “G” block and two “B” blocks. Part #2 820 contains two “G” blocks, one “B” block, and two “R” blocks. In addition, Part #3 830 contains one “G” block, one “B” block, and one “R” block. In the second stage of the process, these data parts are input to a plurality of distributed mappers. In particular, data in Part #1 is input to a Distributed Mapper #1, data in Part #2 is input to a Distributed Mapper #2, and data in Part #3 is input to a Distributed Mapper #3.

In the third stage of the process, each of the Distributed Mappers #1, #2, and #3, generates three data buckets. The data parts 810, 820, 830 are placed in the respective data buckets based on the type of data record. For example, for Distributed Mapper #1, the three corresponding data buckets contain a “G” block, and two “B” blocks. Note that Part #1 does not contain any “R” blocks, therefore not “R” blocks are in the data bucket. Similarly, for Distributed Mapper #2, the three corresponding data buckets contain two “G” blocks, one “B” block, and two “R” blocks. Moreover, for Distributed Mapper #3, the three corresponding data buckets contain one “G” block, one “B” block, and one “R” block.

In the fourth stage of the process, each of the data buckets is sent to one of a Distributed Reducer #1, a Distributed Reducer #2, or a Distributed Reducer #3 based on the type of data. As shown in FIG. 8, the Distributed Reducer #1 receives the data buckets containing the “G” blocks, the Distributed Reducer #2 receives the data buckets containing the “B” blocks, and the Distributed Reducer #3 receives the data buckets containing the “R” blocks. The Distributed Reducers #1, #2, and #3 then reduce the data as detailed above.

The fifth stage of the process is to output the reorganized data 840. This reorganized data 840 includes Reorganized Part #1 data 850, Reorganized Part #2 data 860, and Reorganized Part #3 data 870. Note that the Reorganized Part #1 data 850 contains a “G” block, Reorganized Part #2 data 860 contains a “B” block, and Reorganized Part #3 data 870 contains a “R” block. A single block of each color is shown to represent the fact that the data has been reduced.

### V. Exemplary Operating Environment

Embodiments of the distributed data reorganization system 100 and method are designed to operate in a computing environment. The following discussion is intended to provide a brief, general description of a suitable computing environment in which embodiments of the distributed data reorganization system 100 and method may be implemented.

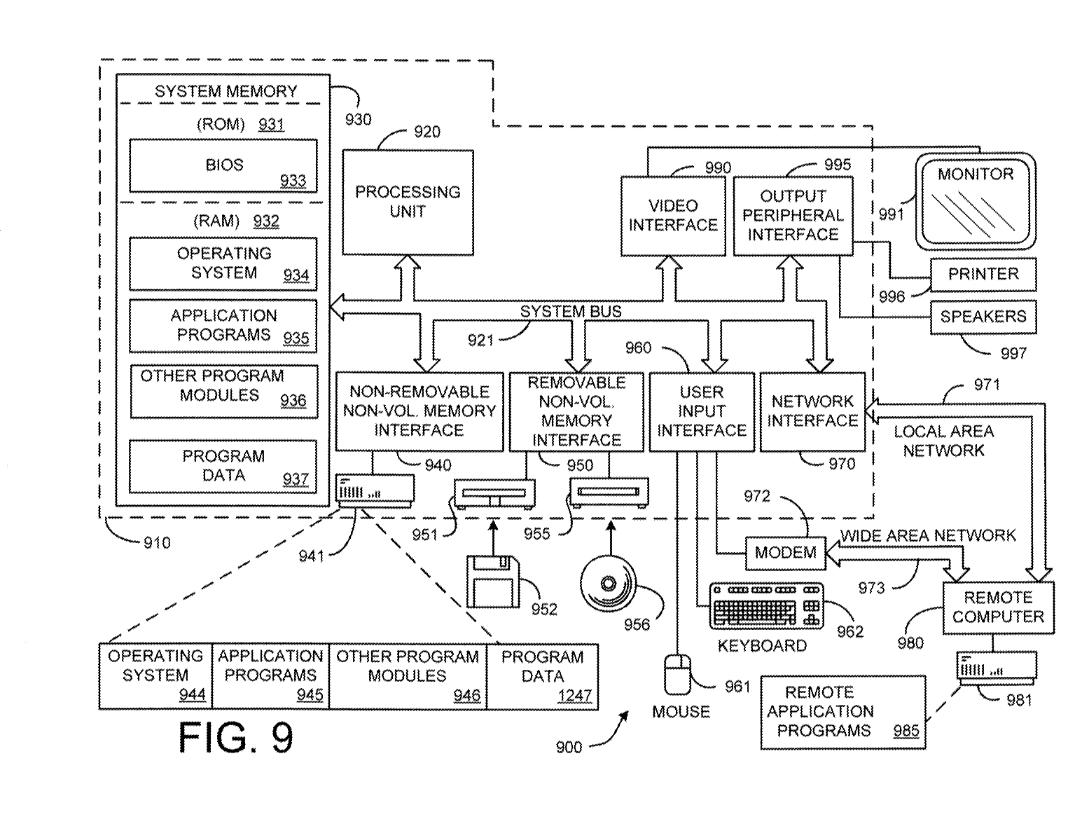

FIG. 9 illustrates an example of a suitable computing system environment in which embodiments of the distributed data reorganization system 100 and method shown in FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment.

Embodiments of the distributed data reorganization system 100 and method are operational with numerous other general purpose or special purpose computing system environments or configurations. Examples of well known computing systems, environments, and/or configurations that may be suitable for use with embodiments of the distributed data reorganization system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the distributed data reorganization system 100 and method may be described in the general context of computer-executable instructions, such as program modules, being executed by a computer. Generally, program modules include routines, programs, objects, components, data structures, etc., that perform particular tasks or implement particular abstract data types. Embodiments of the distributed data reorganization system 100 and method may also be practiced in distributed computing environments where tasks are performed by remote processing devices that are linked through a communications network. In a distributed computing environment, program modules may be located in both local and remote computer storage media including memory storage devices. With reference to FIG. 9, an exemplary system for embodiments of the distributed data reorganization system 100 and method includes a general-purpose computing device in the form of a computer 910.

Components of the computer 910 may include, but are not limited to, a processing unit 920 (such as a central processing unit, CPU), a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer readable media. Computer readable media can be any available media that can be accessed by the computer 910 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 910. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 940 includes computer storage media in the form of volatile and/or nonvolatile memory such as read only memory (ROM) 931 and random access memory (RAM) 932. A basic input/output system 933 (BIOS), containing the basic routines that help to transfer information between elements within the computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936, and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 9, provide storage of computer readable instructions, data structures, program modules and other data for the computer 910. In FIG. 9, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information (or data) into the computer 910 through input devices such as a keyboard 962, pointing device 961, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 920 through a user input interface 960 that is coupled to the system bus 921, but may be connected by other interface and bus structures, such as, for example, a parallel port, game port or a universal serial bus (USB). A monitor 991 or other type of display device is also connected to the system bus 921 via an interface, such as a video interface 990. In addition to the monitor, computers may also include other peripheral output devices such as speakers 997 and printer 996, which may be connected through an output peripheral interface 995.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 9 illustrates remote application programs 985 as residing on memory device 981. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A method implemented on a general-purpose computing device for processing data containing a plurality of data records, comprising:
using the general-purpose computing device to perform the following:
providing a general-purpose parallel execution environment that uses an arbitrary communication acyclic graph having vertices that have multiple inputs and generate multiple outputs;
receiving a mapping criteria;
assigning each of the plurality of data records to one of a plurality of data buckets based on the mapping criteria; and
reducing data in each of the data buckets to generate reorganized data.

2. The method of claim 1, further comprising receiving the mapping criteria from an application written by a developer and running in the general-purpose parallel execution environment.

3. The method of claim 2, further comprising displaying a mapper user interface to a developer such that the developer can use the mapper user interface to push the plurality of data records into a distributed mapper.

4. The method of claim 3, further comprising defining the plurality of data buckets such that each of the plurality of data buckets has a unique data bucket identification.

5. The method of claim 4, further comprising receiving a merge logic from an application written by a developer and running in the general-purpose parallel execution environment.

6. The method of claim 5, further comprising performing data record selection in order to group together data records having a same data bucket identification to generate sets of reducable data records.

7. The method of claim 6, further comprising defining a reducer user interface that allows the developer to input the merge logic.

8. The method of claim 7, further comprising reducing a number of data records in each of the sets of reducable records based on the merge logic.

9. A distributed data reorganization system for mapping and reducing raw data containing a plurality of data records, comprising:
a general-purpose parallel execution environment that uses an arbitrary communication acyclic graph;
vertices of the arbitrary acyclic graph having multiple data inputs and that generate multiple data outputs;
a plurality of distributed mappers in the general-purpose execution environment that take as input the plurality of data records and where each distributed mapper is represented by a vertex of the vertices;
a plurality of data buckets assigned to each of the distributed mappers, where each of the data buckets corresponds to a certain type of data record;
a plurality of distributed reducers in the general-purpose execution environment, where each distributed reducer takes as input data buckets having a same type of data record and where each distributed reducer is represented by a vertex of the vertices; and
reorganized data that is output from the plurality of distributed reducers such that the same type of data records are grouped together and a number of the plurality of data records is reduced.

10. The distributed data reorganization system of claim 9, further comprising an application running the general-purpose parallel execution environment that provides instructions to the plurality of distributed mappers and the plurality of distributed reducers.

11. The distributed data reorganization system of claim 10, further comprising a mapping criteria that is contained in the application that provides mapping instructions to the plurality of distributed mappers.

12. The distributed data reorganization system of claim 11, further comprising a merge logic that is contained in the application that provides reducing and merging instructions to the plurality of distributed reducers.

13. The distributed data reorganization system of claim 12, further comprising a reducer user interface that allows a developer to input the merge logic.

14. The distributed data reorganization system of claim 9, further comprising a mapper user interface that allows a developer to push the plurality of data records into each of the plurality of distributed mappers.

15. The distributed data reorganization system of claim 9, wherein the general-purpose parallel execution environment is DryadNebula.

16. A computer-implemented method for reorganizing raw data containing a plurality of data records, comprising:
providing a DryadNebula general-purpose parallel execution environment having an arbitrary communication directed acyclic graph that contains vertices that receive multiple inputs and generate multiple outputs;
displaying a mapper user interface to a developer so that the developer can use the interface to push the plurality of data records to a plurality of distributed mappers;
defining a data buckets each having a unique data bucket identification;
selecting a data record from the plurality of data records;
assigning the selected data record to a data bucket based on a mapping criteria;
repeating the selecting and assigning until each of the plurality of data records have been mapped to generate mapped data records;
inputting the mapped data records and their associated data bucket identifications to a plurality of distributed reducers;
grouping together those mapped data records having a same data bucket identification to obtain sets of reducable data records; and
processing the sets of reducable data records to generate a reorganized plurality of data records.

17. The computer-implemented method of claim 16, further comprising:
defining a reducer user interface that allows the developer to input merge logic; and
reducing a number of data records in each of the sets of reducable records based on the merge logic.

18. The computer-implemented method of claim 16, further comprising:
determining whether an assigned data bucket is at or near its memory capacity; and
if so, then writing data records in the assigned data bucket to a disk and then purging the data records from the assigned data bucket.

19. The computer-implemented method of claim 18, further comprising:
determining whether a subsequent process requires sorted data; and
if so, then sorting data records in the assigned data bucket.

20. The computer-implemented method of claim 16, further comprising receiving the mapping criteria from an application written by the developer and running in the DryadNebula general-purpose parallel execution environment.
